(19) United States
(12) Patent Application Publication
(10) Pub. No.: US 2023/0388990 A1
(43) Pub. Date: Nov. 30, 2023

(54) TECHNIQUES FOR FREQUENCY ERROR CORRECTION

(71) Applicant: QUALCOMM Incorporated, San Diego, CA (US)

(72) Inventors: Paolo MINERO, La Jolla, CA (US); Ajay K.R. BODDU, San Diego, CA (US); Scott HOOVER, Del Mar, CA (US); Kai XIE, San Diego, CA (US); Levent AYDIN, San Diego, CA (US); Aamod KHANDEKAR, San Diego, CA (US); Brian Clarke BANISTER, San Diego, CA (US)

(21) Appl. No.: 18/313,052

(22) Filed: May 5, 2023

Related U.S. Application Data
(60) Provisional application No. 63/365,576, filed on May 31, 2022.

(51) Int. Cl. H04W 72/0453

(52) U.S. Cl. CPC H04W 72/0453

(57) ABSTRACT

Various aspects of the present disclosure generally relate to wireless communication. In some aspects, a user equipment (UE) may communicate via a first component carrier (CC) during a first time period. The UE may communicate via a second CC during a second time period. The UE may receive a first indication to deactivate the second CC during a third time period that at least partially overlaps with the first time period. The UE may receive a second indication to activate the second CC for communication during a fourth time period. The UE may communicate via the second component carrier during the fourth time period using an initial frequency error correction at a beginning of the fourth time period, the initial frequency error correction based at least in part on a frequency error of the first CC during the third time period. Numerous other aspects are described.

### CROSS-REFERENCE TO RELATED APPLICATION

This Patent Application claims priority to Provisional Patent Application No. 63/365,576, filed on May 31, 2022, entitled “TECHNIQUES FOR FREQUENCY ERROR CORRECTION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for techniques for frequency error correction.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include communicating via a first component carrier during a first time period. The method may include communicating via a second component carrier during a second time period that at least partially overlaps with the first time period. The method may include receiving a first indication to deactivate the second component carrier during a third time period that is after the second time period and at least partially overlaps with the first time period. The method may include receiving a second indication to activate the second component carrier for communication during a fourth time period that is after the third time period. The method may include communicating via the second component carrier during the fourth time period based at least in part on using an initial frequency error correction at a beginning of the fourth time period, the initial frequency error correction based at least in part on a frequency error of the first component carrier during the third time period.

Some aspects described herein relate to a UE for wireless communication. The UE may include a memory and one or more processors coupled to the memory. The one or more processors may be configured to communicate via a first component carrier during a first time period. The one or more processors may be configured to communicate via a second component carrier during a second time period that at least partially overlaps with the first time period. The one or more processors may be configured to receive a first indication to deactivate the second component carrier during a third time period that is after the second time period and at least partially overlaps with the first time period. The one or more processors may be configured to receive a second indication to activate the second component carrier for communication during a fourth time period that is after the third time period. The one or more processors may be configured to communicate via the second component carrier during the fourth time period based at least in part on using an initial frequency error correction at a beginning of the fourth time period, the initial frequency error correction based at least in part on a frequency error of the first component carrier during the third time period.

Some aspects described herein relate to a non-transitory computer-readable medium that stores a set of instructions for wireless communication by a UE. The set of instructions, when executed by one or more processors of the UE, may cause the UE to communicate via a first component carrier during a first time period. The set of instructions, when executed by one or more processors of the UE, may cause the UE to communicate via a second component carrier during a second time period that at least partially overlaps with the first time period. The set of instructions, when executed by one or more processors of the UE, may cause the UE to receive a first indication to deactivate the second component carrier during a third time period that is after the second time period and at least partially overlaps with the first time period. The set of instructions, when executed by one or more processors of the UE, may cause the UE to receive a second indication to activate the second component carrier for communication during a fourth time period that is after the third time period. The set of instructions, when executed by one or more processors of the UE, may cause the UE to communicate via the second component carrier during the fourth time period based at least in part on using an initial frequency error correction at a beginning of the fourth time period, the initial frequency error correction based at least in part on a frequency error of the first component carrier during the third time period.

Some aspects described herein relate to an apparatus for wireless communication. The apparatus may include means for communicating via a first component carrier during a first time period. The apparatus may include means for communicating via a second component carrier during a second time period that at least partially overlaps with the first time period. The apparatus may include means for receiving a first indication to deactivate the second component carrier during a third time period that is after the second time period and at least partially overlaps with the first time period. The apparatus may include means for receiving a second indication to activate the second component carrier for communication during a fourth time period that is after the third time period. The apparatus may include means for communicating via the second component carrier during the fourth time period based at least in part on using an initial frequency error correction at a beginning of the fourth time period, the initial frequency error correction based at least in part on a frequency error of the first component carrier during the third time period.

Some aspects described herein relate to a method of wireless communication performed by a user equipment UE. The method may include communicating via a first component carrier during a first time period. The method may include communicating via a second component carrier during a second time period that at least partially overlaps with the first time period. The method may include receiving a first indication to deactivate the second component carrier during a third time period that is after the second time period and at least partially overlaps with the first time period. The method may include receiving one or more reference signals during the third time period. The method may include receiving a second indication to activate the second component carrier for communication during a fourth time period that is after the third time period. The method may include communicating via the second component carrier during the fourth time period based at least in part on using an initial frequency error correction at a beginning of the fourth time period, the initial frequency error correction based at least in part on the one or more reference signals received during the third time period.

Some aspects described herein relate to a user equipment UE for wireless communication. The user equipment may include one or more memories and one or more processors coupled to the one or more memories. The one or more processors may be configured to communicate via a first component carrier during a first time period. The one or more processors may be configured to communicate via a second component carrier during a second time period that at least partially overlaps with the first time period. The one or more processors may be configured to receive a first indication to deactivate the second component carrier during a third time period that is after the second time period and at least partially overlaps with the first time period. The one or more processors may be configured to receive one or more reference signals during the third time period. The one or more processors may be configured to receive a second indication to activate the second component carrier for communication during a fourth time period that is after the third time period. The one or more processors may be configured to communicate via the second component carrier during the fourth time period based at least in part on using an initial frequency error correction at a beginning of the fourth time period, the initial frequency error correction based at least in part on the one or more reference signals received during the third time period.

Some aspects described herein relate to a non-transitory computer-readable medium that stores a set of instructions for wireless communication by a user equipment UE. The set of instructions, when executed by one or more processors of the UE, may cause the UE to communicate via a first component carrier during a first time period. The set of instructions, when executed by one or more processors of the UE, may cause the UE to communicate via a second component carrier during a second time period that at least partially overlaps with the first time period. The set of instructions, when executed by one or more processors of the UE, may cause the UE to receive a first indication to deactivate the second component carrier during a third time period that is after the second time period and at least partially overlaps with the first time period. The set of instructions, when executed by one or more processors of the UE, may cause the UE to receive one or more reference signals during the third time period. The set of instructions, when executed by one or more processors of the UE, may cause the UE to receive a second indication to activate the second component carrier for communication during a fourth time period that is after the third time period. The set of instructions, when executed by one or more processors of the UE, may cause the UE to communicate via the second component carrier during the fourth time period based at least in part on using an initial frequency error correction at a beginning of the fourth time period, the initial frequency error correction based at least in part on the one or more reference signals received during the third time period.

Some aspects described herein relate to an apparatus for wireless communication. The apparatus may include means for communicating via a first component carrier during a first time period. The apparatus may include means for communicating via a second component carrier during a second time period that at least partially overlaps with the first time period. The apparatus may include means for receiving a first indication to deactivate the second component carrier during a third time period that is after the second time period and at least partially overlaps with the first time period. The apparatus may include means for receiving one or more reference signals during the third time period. The apparatus may include means for receiving a second indication to activate the second component carrier for communication during a fourth time period that is after the third time period. The apparatus may include means for communicating via the second component carrier during the fourth time period based at least in part on using an initial frequency error correction at a beginning of the fourth time period, the initial frequency error correction based at least in part on the one or more reference signals received during the third time period.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of carrier aggregation, in accordance with the present disclosure.

FIG. 5 is a diagram illustrating an example of frequency error associated with carrier aggregation, in accordance with the present disclosure.

FIG. 6 is a diagram of an example associated with frequency error correction, in accordance with the present disclosure.

FIG. 7 is a diagram illustrating an example associated with frequency error correction, in accordance with the present disclosure.

FIG. 8 is a diagram illustrating an example process performed, for example, by a UE, in accordance with the present disclosure.

FIG. 9 is a diagram of an example apparatus for wireless communication, in accordance with the present disclosure.

FIG. 10 is a diagram illustrating an example associated with frequency error correction, in accordance with the present disclosure.

FIG. 11 is a diagram illustrating an example process performed, for example, by a UE, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Various aspects relate generally to identifying an initial frequency error of a component carrier. Some aspects more specifically relate to using a frequency error of a first (in time) component carrier to identify a frequency error of a second (after the first component carrier) component carrier. In some examples, the first component carrier may include a primary component carrier (primary cell (PCell)) and the second component carrier may include a secondary component carrier (secondary cell (SCell)). In some aspects, a UE may communicate via the second component carrier during a first time period, during which time the UE identifies a frequency error (frequency drift) of the second component carrier. The UE may deactivate the secondary cell and may continue communicating via the first cell. While the secondary cell is inactive, a frequency error may change from the frequency error identified when communicating via the secondary cell. Without the second component carrier being active, the UE may not be able to directly detect the change in frequency error, so the UE may detect a change in frequency error of the first component carrier. When reactivating the secondary cell, the UE may use a most-recently detected frequency error of the second cell and the change in frequency error of the first component carrier to identify an initial frequency error for the second cell upon reactivation.

Particular aspects of the subject matter described in this disclosure can be implemented to realize one or more of the following potential advantages. In some examples, by using a detected change in the first component carrier the described techniques can be used to improve accuracy of the initial frequency error when reactivating the second component carrier. In this way, the UE may conserve computing, power, communication, and network resources that may have otherwise been used to identify a correct frequency error from a less-accurate initial frequency error, and/or based at least in part on failing to establish a connection with the second cell based at least in part on the initial frequency error being too inaccurate.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

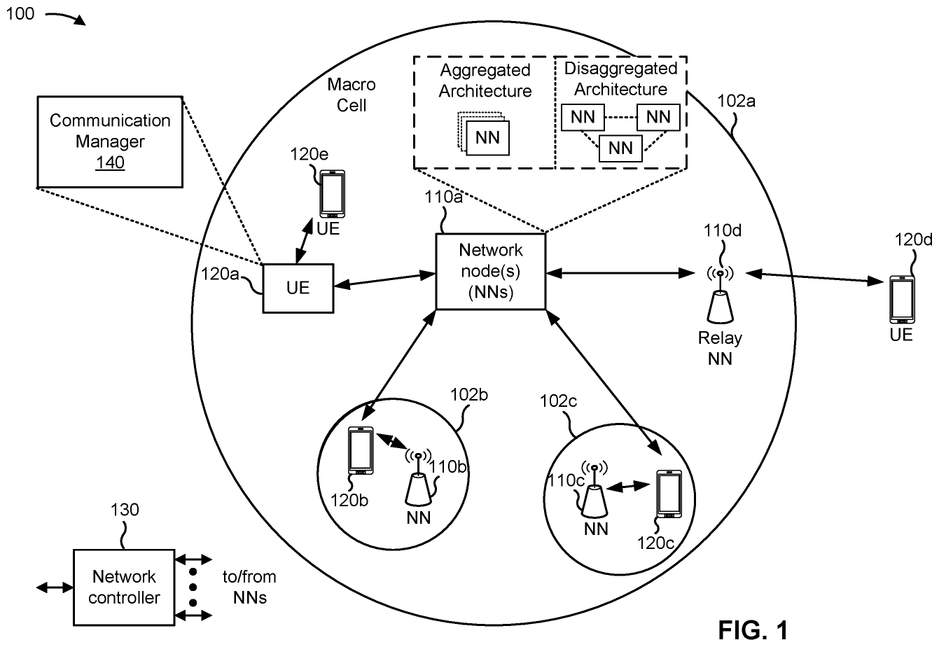

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may communicate via a first component carrier during a first time period; communicate via a second component carrier during a second time period that at least partially overlaps with the first time period; receive a first indication to deactivate the second component carrier during a third time period that is after the second time period and at least partially overlaps with the first time period; receive a second indication to activate the second component carrier for communication during a fourth time period that is after the third time period; and communicate via the second component carrier during the fourth time period based at least in part on using an initial frequency error correction at a beginning of the fourth time period, the initial frequency error correction based at least in part on a frequency error of the first component carrier during the third time period.

In some aspects, the UE 120 may include a communication manager 140. As described in more detail elsewhere herein, the communication manager 140 may communicate via a first component carrier during a first time period; communicate via a second component carrier during a second time period that at least partially overlaps with the first time period; receive a first indication to deactivate the second component carrier during a third time period that is after the second time period and at least partially overlaps with the first time period; receive one or more reference signals during the third time period; receive a second indication to activate the second component carrier for communication during a fourth time period that is after the third time period; and communicate via the second component carrier during the fourth time period based at least in part on using an initial frequency error correction at a beginning of the fourth time period, the initial frequency error correction based at least in part on the one or more reference signals received during the third time period.

Additionally, or alternatively, the communication manager 140 may perform one or more other operations described herein.

As indicated above, FIG. 1 is provided as an example. Other examples may differ from what is described with regard to FIG. 1.

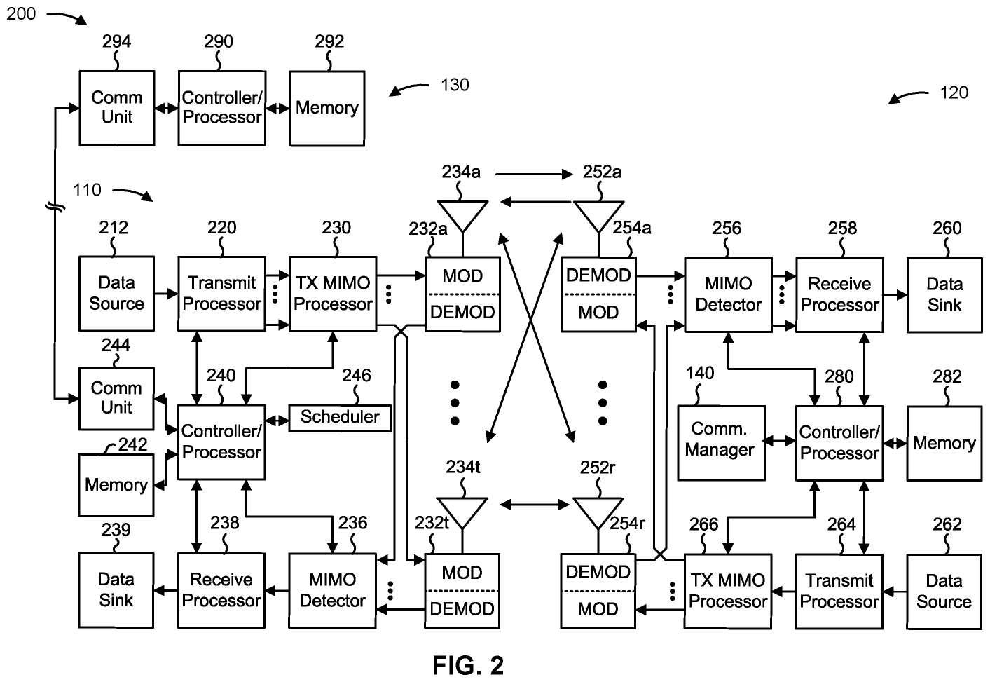

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCS s) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

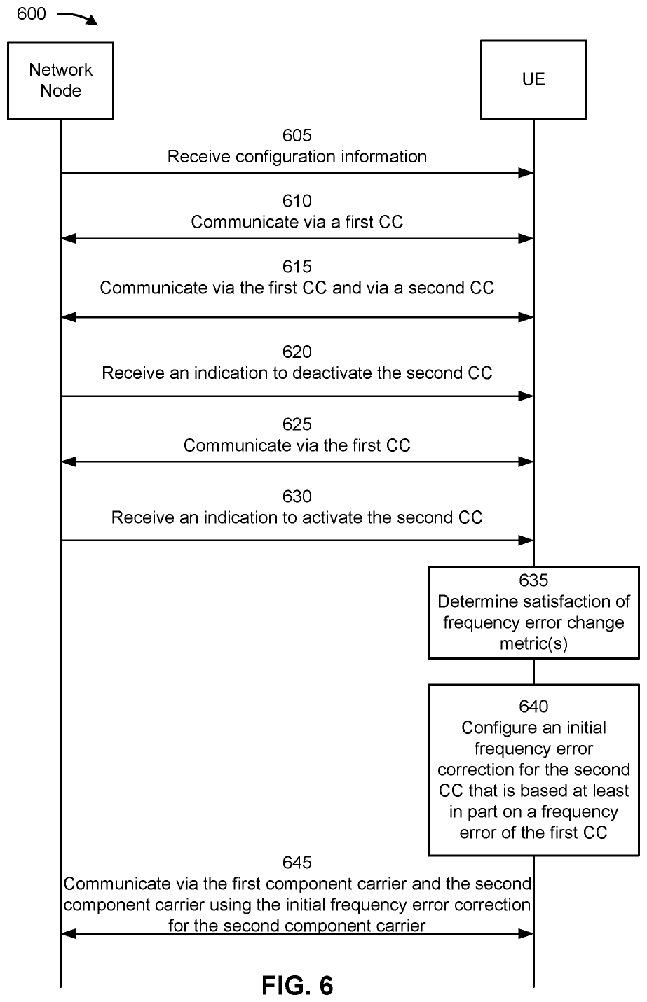

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-9).

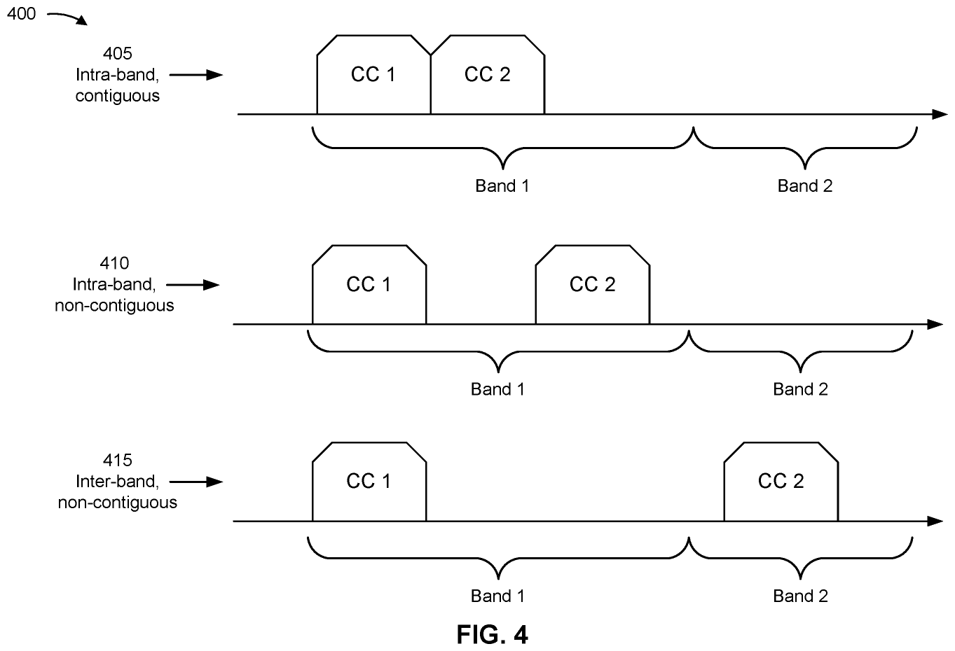

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

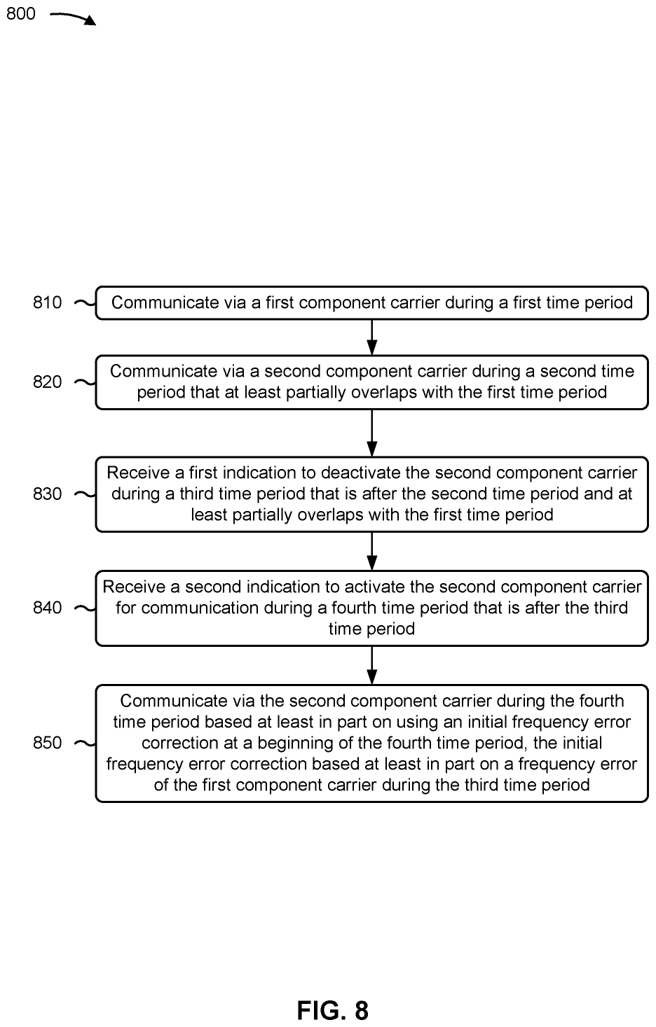

The controller/processor 240 of the network node 110, the controller/processor 280 of the UE 120, and/or any other component(s) of FIG. 2 may perform one or more techniques associated with frequency error correction, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8 and/or other processes as described herein. In some examples, executing instructions may include running the instructions, converting the instructions, compiling the instructions, and/or interpreting the instructions, among other examples.

In some aspects, a UE (e.g., the UE 120) includes means for communicating via a first component carrier during a first time period; means for communicating via a second component carrier during a second time period that at least partially overlaps with the first time period; means for receiving a first indication to deactivate the second component carrier during a third time period that is after the second time period and at least partially overlaps with the first time period; means for receiving a second indication to activate the second component carrier for communication during a fourth time period that is after the third time period; and/or means for communicating via the second component carrier during the fourth time period based at least in part on using an initial frequency error correction at a beginning of the fourth time period, the initial frequency error correction based at least in part on a frequency error of the first component carrier during the third time period.

In some aspects, the user equipment (UE) includes means for communicating via a first component carrier during a first time period; means for communicating via a second component carrier during a second time period that at least partially overlaps with the first time period; means for receiving a first indication to deactivate the second component carrier during a third time period that is after the second time period and at least partially overlaps with the first time period; means for receiving one or more reference signals during the third time period; means for receiving a second indication to activate the second component carrier for communication during a fourth time period that is after the third time period; and/or means for communicating via the second component carrier during the fourth time period based at least in part on using an initial frequency error correction at a beginning of the fourth time period, the initial frequency error correction based at least in part on the one or more reference signals received during the third time period. The means for the user equipment (UE) to perform operations described herein may include, for example, one or more of communication manager 140, antenna 252, modem 254, MIMO detector 256, receive processor 258, transmit processor 264, TX MIMO processor 266, controller/processor 280, or memory 282.

The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

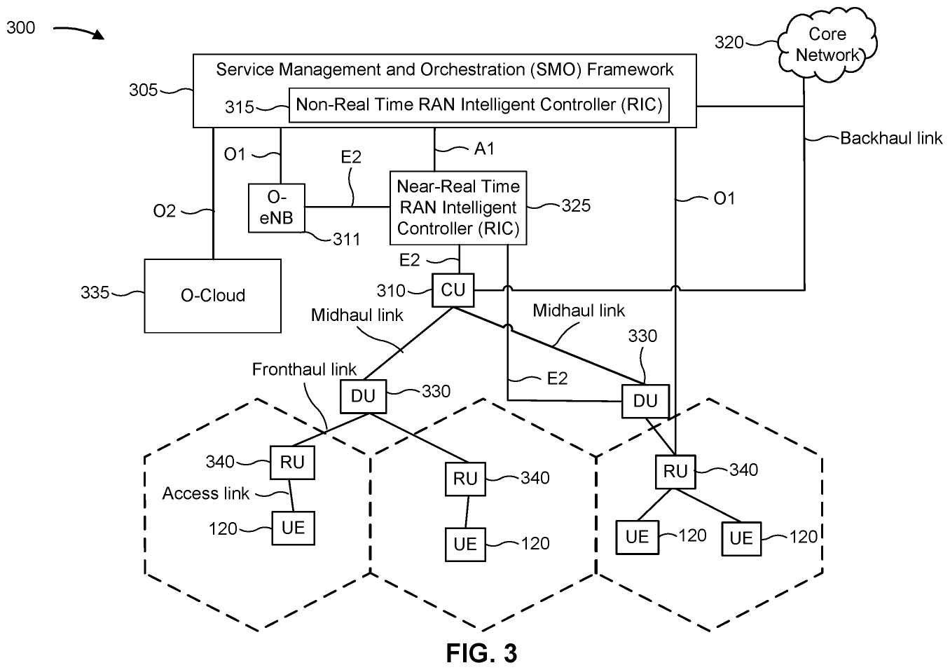

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 335) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400 of carrier aggregation, in accordance with the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in an RRC message, downlink control information (DCI), and/or another signaling message.

As shown by reference number 405, in some aspects, carrier aggregation may be configured in an intra-band contiguous mode where the aggregated carriers are contiguous to one another and are in the same band. As shown by reference number 410, in some aspects, carrier aggregation may be configured in an intra-band non-contiguous mode where the aggregated carriers are non-contiguous to one another and are in the same band. As shown by reference number 415, in some aspects, carrier aggregation may be configured in an inter-band non-contiguous mode where the aggregated carriers are non-contiguous to one another and are in different bands.

In carrier aggregation, a UE 120 may be configured with a primary carrier or PCell and one or more secondary carriers or SCells. In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

In some networks, the UE 120 may communicate via a first component carrier and not a second component carrier during a first time period. The UE may also communicate via the first component carrier and the second component carrier during a second time period. The UE may alternate between periods of communication with only one of the first component carrier or the second component carrier and communication with both of the first component carrier and the second component carrier.

As indicated above, FIG. 4 is provided as an example. Other examples may differ from what is described with regard to FIG. 4.

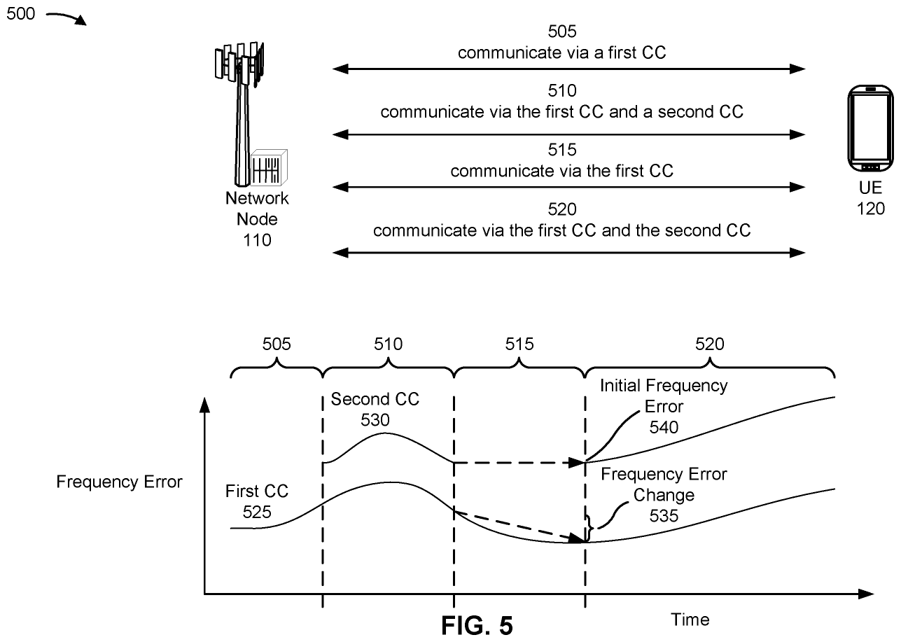

FIG. 5 is a diagram illustrating an example 500 of frequency error associated with carrier aggregation, in accordance with the present disclosure.

As shown by reference number 505, the UE may communicate via a first component carrier during a first time period. As shown by reference number 510, the UE may communicate via the first component carrier and via a second component carrier during a second time period. As shown by reference number 515, the UE may communicate via the first component carrier and not via the second component carrier during a third time period. As shown by reference number 520, the UE may communicate via the first component carrier and via the second component carrier during a fourth time period. For example, communications described in connection with reference numbers 505-520 may be performed in sequential order.

Communications via the first component carrier may have a first component carrier frequency error 525. Communications via the second component carrier may have a second component carrier frequency error 530. The frequency errors may be based at least in part on a temperature of the UE and/or other environmental parameters that may change during the time periods.

As shown in FIG. 5, the first component carrier frequency error 525 may change during the third time period while the UE does not communicate via the second component carrier. For example, the first component carrier frequency error 525 may be associated with a frequency error change 535. This frequency error change 535 may be based at least in part on changes to an environment and/or a change in temperature of the UE.

During the fourth time period, the UE may use an initial frequency error 540 when resuming communications via the second component carrier. However, the initial frequency error 540 may be inaccurate based at least in part on environmental and/or temperature changes that caused the frequency error change 535. Based at least in part on using an inaccurate initial frequency error 540, the UE may be inaccurate in correcting for the frequency error of the second component carrier when resuming communications. This may cause communication errors that consume power, computing, network, and/or communication resources to detect and correct, and/or may cause the UE to drop the second component carrier. Based at least in part on dropping the second component carrier, the UE may communicate with the network node with unnecessarily low efficiency, with unnecessary latency, and/or using scarce resources of the first component carrier.

The communication errors may be caused based at least in part on modem performance being sensitive to frequency error. For example, a residual frequency error at the UE may have a threshold (e.g., <0.04 parts per million (ppm)) to avoid performance problems. The frequency error may be based at least in part on the temperature of the UE.

In some networks (e.g., an NR network), a frequency tracking loop (FTL) may use synchronization signal blocks (SSBs) and/or tracking reference signals (TRSs) to periodically estimate and correct the frequency error. The FTL may have a limited “pull-in” range, meaning that the FTL may correct only relatively small errors (e.g., 2 ppm). If the error is outside of the FTL pull in range, the UE will eventually drop the call and initiate cell acquisition, which can correct larger errors such as 5 ppm or more.

A source of frequency error may be a variation of a local oscillator around its nominal frequency due to temperature variations. The frequency error (e.g., oscillator frequency error) as a function of temperature may be modeled as a 3rd order polynomial. An oscillator manufacturer may specify a range for c0-c3 parameters (e.g., min, nominal, max). In some devices, temperature gradients may be steep (e.g., having a relatively large effect on frequency error over relatively small changes in temperature). If uncorrected, a corresponding frequency error can fall outside the FTL pull in range, which may cause the UE to drop the second component carrier.

In an example scenario, a primary component carrier (PCC) and a secondary component carrier (SCC) may have a 6.82 ppm error at a first temperature (e.g., 59 degrees Fahrenheit). The SCC is deactivated without releasing its configuration. A modem temperature decreases at the UE, and frequency error reported by the PCC goes down to 4.59 ppm. No update for frequency error is done on the SCC during this time because the SCC is deactivated. The SCC is re-activated and its initial error is initialized with 6.82 ppm, based at least in part on a most recent valid value for the SCC. The error is outside the FTL pull in range, so the FTL “aliases” the error to 9 ppm and the frequency error cannot be corrected, causing performance issues that consume power, computing, network, and communication resources to detect and correct.

In some aspects described herein, a UE may use an initial frequency error for a component carrier that is based at least in part on a frequency error of an additional component carrier in a preceding time period. In some aspects, the UE initial frequency error may be based at least in part on the frequency error of the additional component carrier based at least in part on detecting that a frequency error has changed significantly since a time of deactivation of the component carrier. In this way, the UE may use a more-reliable source of frequency error for initialization after re-activation.

In some aspects, at a time of deactivation, the UE may save both frequency errors (e.g., PCC error and SCC error). At the time a component carrier (e.g., an SCC) is re-activated, the UE may check if the frequency error of the additional component carrier (e.g., a PCC) has changed significantly (e.g., by an amount that satisfies a threshold) compared to a stored value from the additional component carrier at the time of de-activation. If so, the UE may use an initial frequency error for the component carrier that is based at least in part on a latest frequency error of the additional component carrier; otherwise, the UE may resume communication via the component carrier with the stored component carrier error.

In some aspects, the UE may determine to base the initial frequency error for the component carrier on the frequency error of the additional component carrier based at least in part on satisfaction of one or more frequency error change metrics. For example, the one or more frequency error change metrics may include whether a time elapsed since a last valid update (e.g., deactivation time of the component carrier) is too large (e.g., >2 sec), whether the frequency error of the additional component carrier shows too large of a frequency drift (e.g., the variation or the error from the time of component carrier de-activation and the time of component carrier re-activation is larger than a threshold amount, such as 1 ppm), a temperature change is too large (e.g., a change in temperature from the time of component carrier de-activation and the time of component carrier re-activation is larger than a threshold amount, such as 5 degrees F.), among other examples.

In some aspects, the UE may use the frequency error of the additional component carrier in the preceding time period. In some aspects, the UE may adjust a most recent frequency error of the component carrier by an amount of change in the frequency error of the additional component carrier during a deactivation time of the component carrier. In other aspects, the UE may use an adjusted frequency error that is based at least in part on a frequency error of the additional component carrier in the preceding time period with an adjustment for a difference between frequency errors of the component carrier and the additional component carrier observed during a time period when both were active.

Based at least in part on the UE using the initial frequency error for the component carrier that is based at least in part on a frequency error of the additional component carrier during an inactive time period of the component carrier, the UE may have improved accuracy in correcting for the frequency error of the second component carrier when resuming communications. This may reduce communication errors that may have otherwise consumed power, computing, network, and/or communication resources to detect and correct, and/or may cause the UE to avoid dropping the second component carrier. Based at least in part on avoiding dropping the second component carrier, the UE may communicate with the network node with improved efficiency, with improved latency, and/or with reduced consumption of resources of the first component carrier.

FIG. 6 is a diagram of an example 600 associated with frequency error correction, in accordance with the present disclosure. As shown in FIG. 6, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 6. In some aspects, the wireless connection may support carrier aggregation and/or other multi-carrier communications.

As shown by reference number 605, the network node may transmit, and the UE may receive, configuration information. In some aspects, the UE may receive the configuration information via one or more of RRC signaling, one or more medium access control (MAC) control elements (CEs), and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to communicate via a first component carrier (e.g., a PCC) and/or a second component carrier (e.g., an SCC). In some aspects, the configuration information may indicate configurations of the first component carrier and the second component carrier, such as a search space for receiving control messages, a configuration for activating and/or deactivating the second component carrier, and/or bandwidth parts (BWPs) for the first component carrier and the second component carrier, among other examples.

The UE may configure itself based at least in part on the configuration information. In some aspects, the UE may be configured to perform one or more operations described herein based at least in part on the configuration information.

As shown by reference number 610, the UE and the network node may communicate via the first component carrier. For example, the UE may transmit uplink communications to, and/or receive downlink communications from, the network node via the first component carrier during a first time period. In some aspects, communications via the first component carrier may include communications with a relatively high reliability requirement. In some aspects, communications via the first component carrier may have a relatively low bandwidth requirement.

As shown by reference number 615, the UE and the network node may communicate via the first component carrier and via a second component carrier. For example, the UE may transmit uplink communications to, and/or receive downlink communications from, the network node via the first component carrier and via the second component carrier during a second time period. In some aspects, the first component carrier may be a primary component carrier and the second component carrier may be a secondary component carrier.

In some aspects, the UE may communicate via the second component carrier in addition to the first component carrier based at least in part on receiving an indication to activate the second component carrier. In some aspects, the network node may transmit, and the UE may receive, the indication to activate the second component carrier based at least in part on a determination to increase a bandwidth for communications and/or to conserve resources of the first component carrier, among other examples. For example, the UE may receive the indication to activate the second component carrier as a downlink component carrier during the second time period based at least in part on the second time period being associated with a relatively high downlink data volume.

As shown by reference number 620, the UE may receive, and the network node may transmit, an indication to deactivate the second component carrier for a third time period. In some aspects, the indication may include dynamic signaling, such as a MAC layer indication or a DCI, among other examples. In some aspects, the indication to deactivate the second component carrier may not indicate to release a configuration of the second component carrier. In this way, the UE may be able to reactivate the second component carrier without receiving a new configuration for the second component carrier. In some aspects, the UE may receive the indication to deactivate the second component carrier based at least in part on a change in one or more communication parameters.

As shown by reference number 625, the UE and the network node may communicate via the first component carrier (e.g., during the third time period after deactivating the second component carrier). In some aspects, communications via the first component carrier may include communications with a relatively low bandwidth requirement, such that the second component carrier is not necessary for the communications. For example, the UE may pause a connection associated with a relatively high downlink data volume or uplink data volume (e.g., a video stream).

As shown by reference number 630, the UE may receive an indication to activate the second component carrier. In some aspects, the indication may include dynamic signaling, such as a MAC layer indication or a DCI, among other examples. In some aspects, the UE may receive the indication to activate the second component carrier based at least in part on a change in one or more communication parameters. For example, the UE may receive the indication to activate the second component carrier based at least in part on an increase in data volume and/or a load on the first component carrier, among other examples.

As shown by reference number 635, the UE may determine whether satisfaction of one or more frequency error change metrics has occurred. In some aspects, the one or more frequency error change metrics include satisfaction of a time duration threshold by the third time period. For example, the UE may determine that the one or more frequency error change metrics are satisfied based at least in part on the third time period extending for an amount of time that satisfies the time duration threshold (e.g., that is as long or longer than the time duration threshold). Additionally, or alternatively, the UE may determine that the one or more frequency error change metrics are satisfied based at least in part on a change in frequency error of the first component carrier during the third time period satisfying a frequency error change threshold. In some aspects, the UE may determine that the one or more frequency error change metrics are satisfied based at least in part on a temperature change during the third time period satisfying a temperature change threshold.

In some aspects, the time duration threshold, the frequency error change threshold, and/or the temperature change threshold is based at least in part on a capability of the UE (e.g., an error correction capability), a communication protocol, and/or an indication from the network node (e.g., received with the configuration information described in connection with reference number 605), among other examples.

As shown by reference number 640, the UE may configure an initial frequency error correction for the second component carrier that is based at least in part on a frequency error of the first component carrier (e.g., during the third time period). In some aspects, the frequency error of the first component carrier may be a basis for configuring the initial frequency error correction for the second component carrier based at least in part on satisfaction of the one or more frequency error change metrics described in connection with reference number 635.

In some aspects, the UE may configure the initial frequency error correction based at least in part on the frequency error of the second component carrier at an end of the third time period, a difference between frequency errors of the first component carrier and the second component carrier during the second time period, and/or a frequency error of the second component carrier at an end of the second time period, among other examples.

In some aspects, the initial frequency error correction of the second component carrier may be substantially equal to a frequency error correction of the first component carrier that is based at least in part on the frequency error of the first component carrier at an end of the third time period. In some aspects, the initial frequency error correction may be based at least in part on a frequency error of the second component carrier at an end of the second time period and a change in frequency error of the first component carrier during the third time period (e.g., a most recent frequency error of the second component carrier adjusted for a change in frequency error of the first component carrier during an inactive time of the second component carrier). In some aspects, the initial frequency error correction of the second component carrier may be based at least in part on the frequency error of the first component carrier at an end of the third time period, and a difference between a frequency error of the second component carrier and a frequency error of the first component carrier during the second time period (e.g., a most recent frequency error of the first component carrier adjusted for a difference in frequency errors of the component carriers during a time when both component carriers were active).

In some aspects, the frequency error of the first component carrier may be a basis for configuring the initial frequency error correction for the second component carrier based at least in part on communications via the first component carrier and communications via the second component carrier using a same reception chain or transmission chain. For example, the first component carrier and the second component carrier may use a same antenna group for communications. In some aspects, the frequency error of the first component carrier may be a basis for configuring the initial frequency error correction for the second component carrier based at least in part on the first component carrier and the second component carrier being within a same frequency range (e.g., FR2, FR1, and/or a bandwidth part, among other examples).

As shown by reference number 645, the UE and the network node may communicate via the first component carrier and the second component carrier using the initial frequency error correction for the second component carrier. For example, the UE may transmit a communication using the initial frequency error correction and/or receive a communication using the initial frequency error correction.

In some aspects, a first time period may be defined as including time periods in which the UE communicates via at least the first component carrier. For example, communicating in connection with reference numbers 610, 615, 625, and/or 645 may be the first time period. Communicating in connection with reference number 615 may be defined as a second time period that at least partially overlaps with the first time period (e.g., the second time period includes a time at which the UE communications via the second component carrier and at least partially overlaps with the first time period during which the UE communicates via the first component carrier). A third time period may be defined as a time period during which the second component carrier is inactive and the UE continues communicating via the first component carrier. For example, the third time period may be after the second time period and at least partially overlaps with the first time period. A fourth period may be defined as a time period during which the second component carrier is active (e.g., after the third period) and the UE continues to communicate via the first component carrier. The fourth period at least partially overlaps with the first time period.

Based at least in part on the UE using the initial frequency error for the component carrier that is based at least in part on a frequency error of the additional component carrier during an inactive time period of the component carrier, the UE may have improved accuracy in correcting for the frequency error of the second component carrier when resuming communications. This may reduce communication errors that may have otherwise consumed power, computing, network, and/or communication resources to detect and correct, and/or may cause the UE to avoid dropping the second component carrier. Based at least in part on avoiding dropping the second component carrier, the UE may communicate with the network node with improved efficiency, with improved latency, and/or with reduced consumption of scarce resources of the first component carrier.

As indicated above, FIG. 6 is provided as an example. Other examples may differ from what is described with respect to FIG. 6.

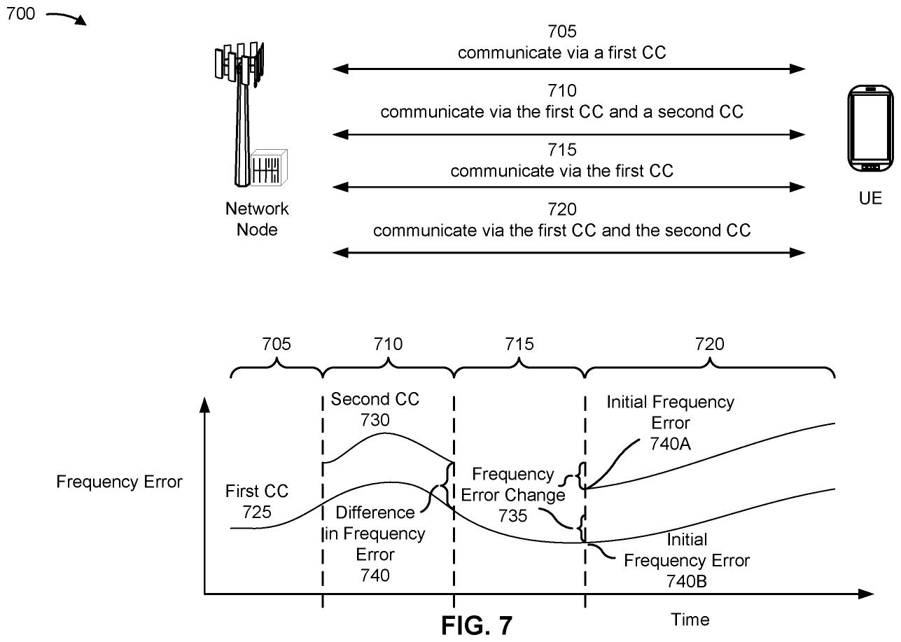

FIG. 7 is a diagram illustrating an example 700 associated with frequency error correction, in accordance with the present disclosure. In example 700, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 7. In some aspects, the wireless connection may support carrier aggregation and/or other multi-carrier communications.

As shown by reference number 705, the UE may communicate via a first component carrier during a first time period. As shown by reference number 710, the UE may communicate via the first component carrier and via a second component carrier during a second time period. As shown by reference number 715, the UE may communicate via the first component carrier and not via the second component carrier during a third time period. As shown by reference number 720, the UE may communicate via the first component carrier and via the second component carrier during a fourth time period. In some aspects, one or more communications described in connection with reference numbers 705-720 may be performed in sequential order.

Communications via the first component carrier may have a first component carrier frequency error 725. Communications via the second component carrier may have a second component carrier frequency error 730. The frequency errors may be based at least in part on a temperature of the UE and/or other environmental parameters that may change during the time periods.

As shown in FIG. 7, the first component carrier frequency error 725 may change during the third time period while the UE does not communicate via the second component carrier. For example, the first component carrier frequency error 725 may be associated with a frequency error change 735. This frequency error change 735 may be based at least in part on changes to an environment and/or a change in temperature of the UE. During the second time period, the first component carrier frequency error 725 and the second component carrier frequency error 730 may have a difference in frequency error 740 (e.g., measured at an end of the second time period).

During the fourth time period, the UE may use an initial frequency error 740 when resuming communications via the second component carrier. In some aspects, initial frequency error 740 may be based at least in part on the first component carrier frequency error 725, the frequency error change 735, the second component carrier frequency error 730 during the second time period, and/or the difference in frequency error 740.

In some aspects, an initial frequency error 740A may be offset from the first component carrier frequency error 725 at the end of the third time period and/or beginning of the fourth time period. The offset may be based at least in part on the frequency error change 735 and/or the difference in frequency error 740. For example, the initial frequency error 740A may be based at least in part on adding the difference in frequency error 740 to the first component carrier frequency error 725 at the end of the third time period and/or beginning of the fourth time period. In some aspects, the initial frequency error 740A may be based at least in part on adding (e.g., a negative value shown in FIG. 7) the frequency error change 735 to the second component carrier frequency error 730 at the end of the second time period.

In some aspects, an initial frequency error 740B may be set to a same value as the first component carrier frequency error 725 at the end of the third time period and/or beginning of the fourth time period. In some aspects, this may be used based at least in part on the first component carrier and the second component carrier operating using a same transmission chain, reception chain, and/or antenna group of the UE. In some aspects, this may be used based at least in part on the first component carrier and the second component carrier operating within a same frequency range.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with techniques for frequency error correction.

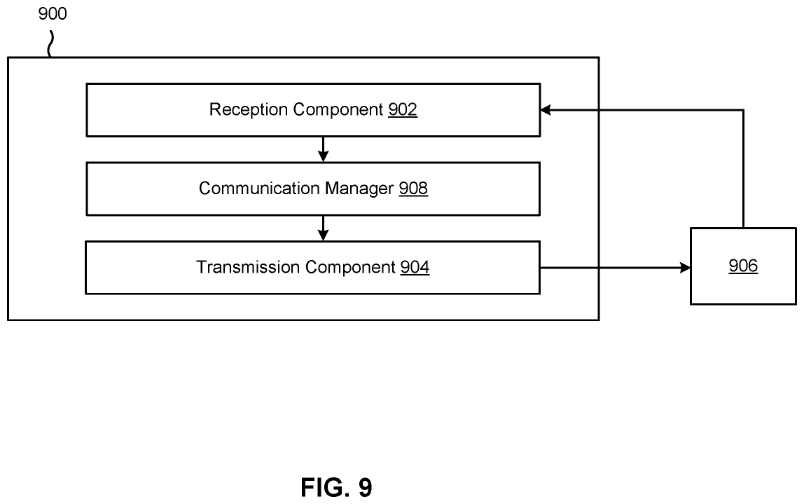

As shown in FIG. 8, in some aspects, process 800 may include communicating via a first component carrier during a first time period (block 810). For example, the UE (e.g., using communication manager 140, reception component 902, and/or transmission component 904, depicted in FIG. 9) may communicate via a first component carrier during a first time period, as described above.

As further shown in FIG. 8, in some aspects, process 800 may include communicating via a second component carrier during a second time period that at least partially overlaps with the first time period (block 820). For example, the UE (e.g., using communication manager 140, reception component 902, and/or transmission component 904, depicted in FIG. 9) may communicate via a second component carrier during a second time period that at least partially overlaps with the first time period, as described above.

As further shown in FIG. 8, in some aspects, process 800 may include receiving a first indication to deactivate the second component carrier during a third time period that is after the second time period and at least partially overlaps with the first time period (block 830). For example, the UE (e.g., using communication manager 140 and/or reception component 902, depicted in FIG. 9) may receive a first indication to deactivate the second component carrier during a third time period that is after the second time period and at least partially overlaps with the first time period, as described above.

As further shown in FIG. 8, in some aspects, process 800 may include receiving a second indication to activate the second component carrier for communication during a fourth time period that is after the third time period (block 840). For example, the UE (e.g., using communication manager 140 and/or reception component 902, depicted in FIG. 9) may receive a second indication to activate the second component carrier for communication during a fourth time period that is after the third time period, as described above.

As further shown in FIG. 8, in some aspects, process 800 may include communicating via the second component carrier during the fourth time period based at least in part on using an initial frequency error correction at a beginning of the fourth time period, the initial frequency error correction based at least in part on a frequency error of the first component carrier during the third time period (block 850). For example, the UE (e.g., using communication manager 140, reception component 902, and/or transmission component 904, depicted in FIG. 9) may communicate via the second component carrier during the fourth time period based at least in part on using an initial frequency error correction at a beginning of the fourth time period, the initial frequency error correction based at least in part on a frequency error of the first component carrier during the third time period, as described above.

Process 800 may include additional aspects, such as any single aspect or any combination of aspects described below and/or in connection with one or more other processes described elsewhere herein.

In a first aspect, the initial frequency error correction is based at least in part on the frequency error of the first component carrier during the third time period based at least in part on satisfaction of one or more frequency error change metrics.

In a second aspect, alone or in combination with the first aspect, the one or more frequency error change metrics comprise satisfaction of a time duration threshold by the third time period, satisfaction of a frequency error change threshold by a change in frequency error of the first component carrier during the third time period, or satisfaction of a temperature change threshold by a temperature change during the third time period.

In a third aspect, alone or in combination with one or more of the first and second aspects, one or more of the time duration threshold, the frequency error change threshold, or the temperature change threshold is based at least in part on one or more of a capability of the UE, a communication protocol, or an indication from a network node associated with the first component carrier or the second component carrier.

In a fourth aspect, alone or in combination with one or more of the first through third aspects, the initial frequency error correction is based at least in part on a frequency error of the first component carrier during the third time period based at least in part on one or more of: communications via the first component carrier and communications via the second component carrier using a same reception chain or transmission chain, or the first component carrier and the second component carrier being within a same frequency range.

In a fifth aspect, alone or in combination with one or more of the first through fourth aspects, the initial frequency error correction being based at least in part on a frequency error of the first component carrier during the third time period comprises the initial frequency error correction being substantially equal to a frequency error correction of the first component carrier that is based at least in part on the frequency error of the first component carrier at an end of the third time period.

In a sixth aspect, alone or in combination with one or more of the first through fifth aspects, the initial frequency error correction being based at least in part on a frequency error of the first component carrier during the third time period comprises the initial frequency error correction being based at least in part on a frequency error of the second component carrier at an end of the second time period, and a change in frequency error of the first component carrier during the third time period.

In a seventh aspect, alone or in combination with one or more of the first through sixth aspects, the initial frequency error correction being based at least in part on a frequency error of the first component carrier during the third time period comprises the initial frequency error correction being based at least in part on the frequency error of the first component carrier at an end of the third time period, and a difference between a frequency error of the second component carrier and a frequency error of the first component carrier during the second time period.

In an eighth aspect, alone or in combination with one or more of the first through seventh aspects, the second component carrier comprises a secondary component carrier.

In a ninth aspect, alone or in combination with one or more of the first through eighth aspects, communicating via the second component carrier during the fourth time period comprises transmitting a communication using the initial frequency error correction, or receiving a communication using the initial frequency error correction.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a communication manager 908 (e.g., the communication manager 140). In some aspects, the communication manager 908 may provide control signals to, or receive control signals from, the reception component 902 and/or transmission component 904 in connection with performing one or more operations described herein.

In some aspects, the apparatus 900 may be configured to perform one or more operations described herein in connection with FIGS. 6-7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 and/or transmission component 904 may communicate via a first component carrier during a first time period. The reception component 902 and/or transmission component 904 may communicate via a second component carrier during a second time period that at least partially overlaps with the first time period. The reception component 902 may receive a first indication to deactivate the second component carrier during a third time period that is after the second time period and at least partially overlaps with the first time period. The reception component 902 may receive a second indication to activate the second component carrier for communication during a fourth time period that is after the third time period. The reception component 902 and/or transmission component 904 may communicate via the second component carrier during the fourth time period based at least in part on using an initial frequency error correction at a beginning of the fourth time period, the initial frequency error correction based at least in part on a frequency error of the first component carrier during the third time period.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: communicating via a first component carrier during a first time period; communicating via a second component carrier during a second time period that at least partially overlaps with the first time period; receiving a first indication to deactivate the second component carrier during a third time period that is after the second time period and at least partially overlaps with the first time period; receiving a second indication to activate the second component carrier for communication during a fourth time period that is after the third time period; and communicating via the second component carrier during the fourth time period based at least in part on using an initial frequency error correction at a beginning of the fourth time period, the initial frequency error correction based at least in part on a frequency error of the first component carrier during the third time period.

Aspect 2: The method of Aspect 1, wherein the initial frequency error correction is based at least in part on the frequency error of the first component carrier during the third time period based at least in part on satisfaction of one or more frequency error change metrics.

Aspect 3: The method of Aspect 2, wherein the one or more frequency error change metrics comprise: satisfaction of a time duration threshold by the third time period; satisfaction of a frequency error change threshold by a change in frequency error of the first component carrier during the third time period; or satisfaction of a temperature change threshold by a temperature change during the third time period.

Aspect 4: The method of Aspect 3, wherein one or more of the time duration threshold, the frequency error change threshold, or the temperature change threshold is based at least in part on one or more of: a capability of the UE, a communication protocol, or an indication from a network node associated with the first component carrier or the second component carrier.

Aspect 5: The method of any of Aspects 1-4, wherein the initial frequency error correction is based at least in part on a frequency error of the first component carrier during the third time period based at least in part on one or more of: communications via the first component carrier and communications via the second component carrier using a same reception chain or transmission chain, or the first component carrier and the second component carrier being within a same frequency range.

Aspect 6: The method of any of Aspects 1-5, wherein the initial frequency error correction being based at least in part on a frequency error of the first component carrier during the third time period comprises: the initial frequency error correction being substantially equal to a frequency error correction of the first component carrier that is based at least in part on the frequency error of the first component carrier at an end of the third time period.

Aspect 7: The method of any of Aspects 1-6, wherein the initial frequency error correction being based at least in part on a frequency error of the first component carrier during the third time period comprises: the initial frequency error correction being based at least in part on: a frequency error of the second component carrier at an end of the second time period, and a change in frequency error of the first component carrier during the third time period.

Aspect 8: The method of any of Aspects 1-7, wherein the initial frequency error correction being based at least in part on a frequency error of the first component carrier during the third time period comprises: the initial frequency error correction being based at least in part on: the frequency error of the first component carrier at an end of the third time period, and a difference between a frequency error of the second component carrier and a frequency error of the first component carrier during the second time period.

Aspect 9: The method of any of Aspects 1-8, wherein the second component carrier comprises a secondary component carrier.

Aspect 10: The method of any of Aspects 1-9, wherein communicating via the second component carrier during the fourth time period comprises: transmitting a communication using the initial frequency error correction, or receiving a communication using the initial frequency error correction.

Aspect 11: An apparatus for wireless communication at a device, comprising a processor; memory coupled with the processor; and instructions stored in the memory and executable by the processor to cause the apparatus to perform the method of one or more of Aspects 1-10.

Aspect 12: A device for wireless communication, comprising a memory and one or more processors coupled to the memory, the one or more processors configured to perform the method of one or more of Aspects 1-10.

Aspect 13: An apparatus for wireless communication, comprising at least one means for performing the method of one or more of Aspects 1-10.

Aspect 14: A non-transitory computer-readable medium storing code for wireless communication, the code comprising instructions executable by a processor to perform the method of one or more of Aspects 1-10.

Aspect 15: A non-transitory computer-readable medium storing a set of instructions for wireless communication, the set of instructions comprising one or more instructions that, when executed by one or more processors of a device, cause the device to perform the method of one or more of Aspects 1-10.

In some aspects, the UE may identify an initial frequency error correction, after a period of inactivity of a component carrier, based at least in part on measurements of reference signals during the period of inactivity. For example, the UE may maintain activity on a primary component carrier (PCell) during a period of inactivity of a secondary component carrier (SCell), with the period of inactivity following a period of activity of the SCell. The UE may use a frequency error correction during the period of activity of the SCell. Rather than use the most recent frequency error correction (e.g., from the period of activity of the SCell) to identify an initial frequency error correction upon reactivation of the SCell, the UE may estimate frequency error using the measurements of the reference signals during the period of inactivity.

In some aspects, the reference signals may include synchronization signal blocks (SSBs) associated with the SCell. In some aspects, the UE may receive the SSBs with a periodicity that is different from a periodicity of receiving SSBs during the period of activity. For example, the UE may receive the SSBs during the period of inactivity with a periodicity that is longer than the periodicity of receiving the SSBs during the period of activity. In this way, the UE may conserve power resources during the period of inactivity.

In some aspects, the UE may estimate the frequency error of the SCell from the reference signals. In some aspects, the UE may identify the initial frequency error correction from the estimate of the frequency error. In some aspects, the UE may identify the initial frequency error correction based at least in part on a frequency error during the activity period, with an adjustment that is based at least in part on a change of frequency error identified from the reference signals.

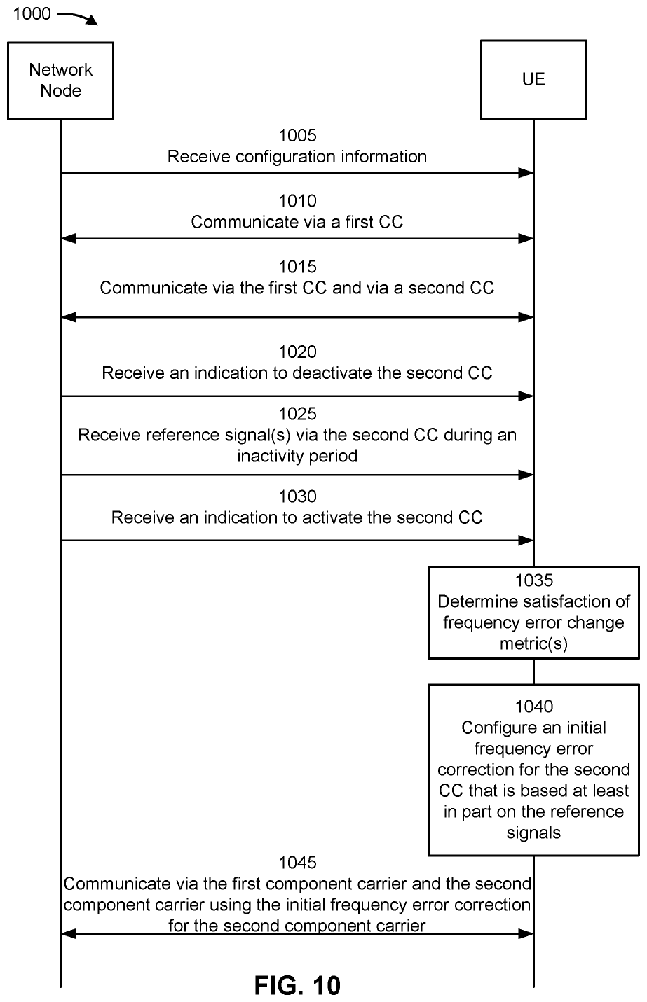

FIG. 10 is a diagram of an example 1000 associated with frequency error correction, in accordance with the present disclosure. As shown in FIG. 10, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 10. In some aspects, the wireless connection may support carrier aggregation and/or other multi-carrier communications.

As shown by reference number 1005, the network node may transmit, and the UE may receive, configuration information. In some aspects, the UE may receive the configuration information via one or more of RRC signaling, one or more medium access control (MAC) control elements (CEs), and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to communicate via a first component carrier (e.g., a PCC) and/or a second component carrier (e.g., an SCC). In some aspects, the configuration information may indicate configurations of the first component carrier and the second component carrier, such as a search space for receiving control messages, a configuration for activating and/or deactivating the second component carrier, and/or bandwidth parts (BWPs) for the first component carrier and the second component carrier, among other examples.

The UE may configure itself based at least in part on the configuration information. In some aspects, the UE may be configured to perform one or more operations described herein based at least in part on the configuration information.

As shown by reference number 1010, the UE and the network node may communicate via the first component carrier. For example, the UE may transmit uplink communications to, and/or receive downlink communications from, the network node via the first component carrier during a first time period. In some aspects, communications via the first component carrier may include communications with a relatively high reliability requirement. In some aspects, communications via the first component carrier may have a relatively low bandwidth requirement.

As shown by reference number 1015, the UE and the network node may communicate via the first component carrier and via a second component carrier. For example, the UE may transmit uplink communications to, and/or receive downlink communications from, the network node via the first component carrier and via the second component carrier during a second time period. In some aspects, the first component carrier may be a primary component carrier and the second component carrier may be a secondary component carrier.

In some aspects, the UE may communicate via the second component carrier in addition to the first component carrier based at least in part on receiving an indication to activate the second component carrier. In some aspects, the network node may transmit, and the UE may receive, the indication to activate the second component carrier based at least in part on a determination to increase a bandwidth for communications and/or to conserve resources of the first component carrier, among other examples. For example, the UE may receive the indication to activate the second component carrier as a downlink component carrier during the second time period based at least in part on the second time period being associated with a relatively high downlink data volume.

In some aspects, the UE may receive one or more SSBs via the second component carrier during the second time period. For example, the UE may receive the one or more SSBs having a periodicity that is associated with the second component carrier being active for the UE.

As shown by reference number 1020, the UE may receive, and the network node may transmit, an indication to deactivate the second component carrier for a third time period (also referred to as an “inactivity period”). In some aspects, the indication may include dynamic signaling, such as a MAC layer indication or a DCI, among other examples. In some aspects, the indication to deactivate the second component carrier may not indicate to release a configuration of the second component carrier. In this way, the UE may be able to reactivate the second component carrier without receiving a new configuration for the second component carrier. In some aspects, the UE may receive the indication to deactivate the second component carrier based at least in part on a change in one or more communication parameters.

As shown by reference number 1025, the UE may receive, and the network node may transmit, one or more reference signals via the second component carrier during the inactivity period. In some aspects, the one or more reference signals may include one or more SSBs. In some aspects, the one or more reference signals may be periodic reference signals. In some aspects, a periodicity of the one or more reference signals may be longer (e.g., less-frequent) than a same type of reference signal during the second time period (e.g., an active period of the second component carrier). In some aspects, the UE may measure frequency error of the second component carrier during the inactivity period based at least in part on the one or more reference signals.

In some aspects, the UE and the network node may communicate via the first component carrier during the third time period after deactivating the second component carrier. In some aspects, communications via the first component carrier may include communications with a relatively low bandwidth requirement, such that the second component carrier is not necessary for the communications. For example, the UE may pause a connection associated with a relatively high downlink data volume or uplink data volume (e.g., a video stream).

As shown by reference number 1030, the UE may receive an indication to activate the second component carrier. In some aspects, the indication may include dynamic signaling, such as a MAC layer indication or a DCI, among other examples. In some aspects, the UE may receive the indication to activate the second component carrier based at least in part on a change in one or more communication parameters. For example, the UE may receive the indication to activate the second component carrier based at least in part on an increase in data volume and/or a load on the first component carrier, among other examples.

As shown by reference number 1035, the UE may determine whether satisfaction of one or more frequency error change metrics has occurred. In some aspects, the one or more frequency error change metrics include satisfaction of a time duration threshold by the third time period. For example, the UE may determine that the one or more frequency error change metrics are satisfied based at least in part on the third time period extending for an amount of time that satisfies the time duration threshold (e.g., that is as long or longer than the time duration threshold). Additionally, or alternatively, the UE may determine that the one or more frequency error change metrics are satisfied based at least in part on a change in frequency error of the second component carrier during the third time period satisfying a frequency error change threshold, based at least in part on measurement of the one or more reference signals. In some aspects, the UE may determine that the one or more frequency error change metrics are satisfied based at least in part on a temperature change during the third time period satisfying a temperature change threshold.

In some aspects, the time duration threshold, the frequency error change threshold, and/or the temperature change threshold is based at least in part on a capability of the UE (e.g., an error correction capability), a communication protocol, and/or an indication from the network node (e.g., received with the configuration information described in connection with reference number 1005), among other examples.

As shown by reference number 1040, the UE may configure an initial frequency error correction for the second component carrier that is based at least in part on the one or more reference signals. For example, the UE may estimate the frequency error as an absolute frequency error using the one or more reference signals. In some aspects, the UE may measure the one or more reference signals to identify a change in frequency error during the inactivity period (e.g., during the third time period). The UE may then use the identified change in the frequency error during the inactivity period to adjust a frequency error and/or frequency error correction associated with an active period before the inactivity period. In some aspects, the one or more reference signals (e.g., frequency error measured based at least in part on the one or more reference signals) of the second component carrier may be a basis for configuring the initial frequency error correction for the second component carrier during a fourth time period associated with reactivation of the second component carrier, based at least in part on frequency error change metrics described in connection with reference number 1035.

As shown by reference number 1045, the UE and the network node may communicate via the first component carrier and the second component carrier using the initial frequency error correction for the second component carrier. For example, the UE may transmit a communication using the initial frequency error correction and/or receive a communication using the initial frequency error correction.

In some aspects, a first time period may be defined as including time periods in which the UE communicates via at least the first component carrier. For example, communicating in connection with reference numbers 1010, 1015, 1025, 1030, and/or 1045 may be the first time period. Communicating in connection with reference number 1015 may be defined as a second time period that at least partially overlaps with the first time period (e.g., the second time period includes a time at which the UE communications via the second component carrier and at least partially overlaps with the first time period during which the UE communicates via the first component carrier). A third time period may be defined as a time period during which the second component carrier is inactive and the UE continues communicating via the first component carrier. For example, the third time period may be after the second time period and at least partially overlaps with the first time period. A fourth period may be defined as a time period during which the second component carrier is active (e.g., after the third period) and the UE continues to communicate via the first component carrier. The fourth period at least partially overlaps with the first time period.

Based at least in part on the UE using the initial frequency error for the component carrier that is based at least in part on a measurement of one or more reference signals received via the second component carrier during an inactive time period of the second component carrier, the UE may have improved accuracy in correcting for the frequency error of the second component carrier when resuming communications. This may reduce communication errors that may have otherwise consumed power, computing, network, and/or communication resources to detect and correct, and/or may cause the UE to avoid dropping the second component carrier. Based at least in part on avoiding dropping the second component carrier, the UE may communicate with the network node with improved efficiency, with improved latency, and/or with reduced consumption of scarce resources of the first component carrier.

As indicated above, FIG. 10 is provided as an example. Other examples may differ from what is described with respect to FIG. 10.

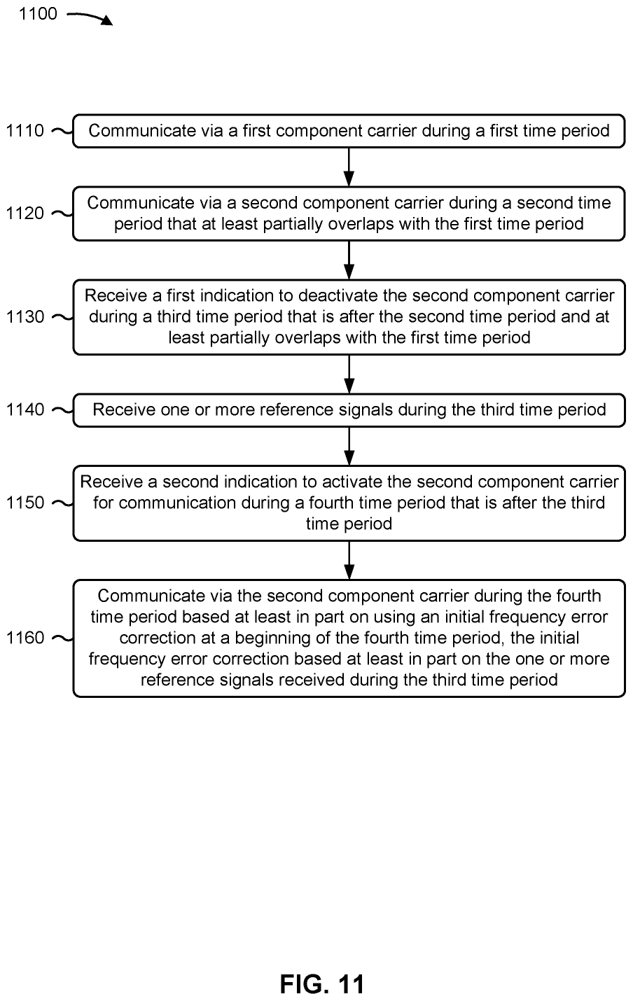

FIG. 11 is a diagram illustrating an example process 1100 performed, for example, by a UE, in accordance with the present disclosure. Example process 1100 is an example where the UE (e.g., UE 120) performs operations associated with techniques for frequency error correction.

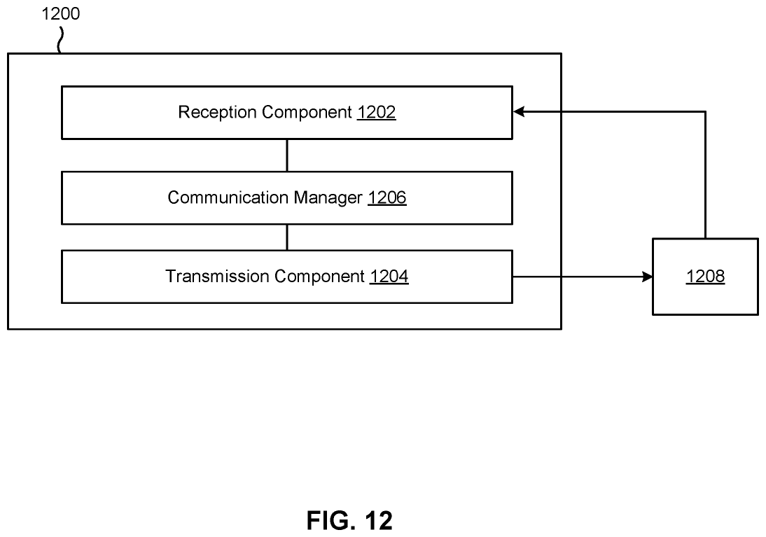

As shown in FIG. 11, in some aspects, process 1100 may include communicating via a first component carrier during a first time period (block 1110). For example, the UE (e.g., using reception component 1202, transmission component 1204, and/or communication manager 1206, depicted in FIG. 12) may communicate via a first component carrier during a first time period, as described above.

As further shown in FIG. 11, in some aspects, process 1100 may include communicating via a second component carrier during a second time period that at least partially overlaps with the first time period (block 1120). For example, the UE (e.g., using reception component 1202, transmission component 1204, and/or communication manager 1206, depicted in FIG. 12) may communicate via a second component carrier during a second time period that at least partially overlaps with the first time period, as described above.

As further shown in FIG. 11, in some aspects, process 1100 may include receiving a first indication to deactivate the second component carrier during a third time period that is after the second time period and at least partially overlaps with the first time period (block 1130). For example, the UE (e.g., using reception component 1202 and/or communication manager 1206, depicted in FIG. 12) may receive a first indication to deactivate the second component carrier during a third time period that is after the second time period and at least partially overlaps with the first time period, as described above.

As further shown in FIG. 11, in some aspects, process 1100 may include receiving one or more reference signals during the third time period (block 1140). For example, the UE (e.g., using reception component 1202 and/or communication manager 1206, depicted in FIG. 12) may receive one or more reference signals during the third time period, as described above.

As further shown in FIG. 11, in some aspects, process 1100 may include receiving a second indication to activate the second component carrier for communication during a fourth time period that is after the third time period (block 1150). For example, the UE (e.g., using reception component 1202 and/or communication manager 1206, depicted in FIG. 12) may receive a second indication to activate the second component carrier for communication during a fourth time period that is after the third time period, as described above.

As further shown in FIG. 11, in some aspects, process 1100 may include communicating via the second component carrier during the fourth time period based at least in part on using an initial frequency error correction at a beginning of the fourth time period, the initial frequency error correction based at least in part on the one or more reference signals received during the third time period (block 1160). For example, the UE (e.g., using reception component 1202, transmission component 1204, and/or communication manager 1206, depicted in FIG. 12) may communicate via the second component carrier during the fourth time period based at least in part on using an initial frequency error correction at a beginning of the fourth time period, the initial frequency error correction based at least in part on the one or more reference signals received during the third time period, as described above.

Process 1100 may include additional aspects, such as any single aspect or any combination of aspects described below and/or in connection with one or more other processes described elsewhere herein.

In a first aspect, the one or more reference signals comprises one or more SSBs.

In a second aspect, alone or in combination with the first aspect, process 1100 includes receiving a set of reference signals during the second time period and with a first periodicity, wherein receiving the one or more reference signals during the third time period comprises receiving the one or more reference signals during the third time period with a second periodicity, wherein the first periodicity is shorter than the second periodicity.

In a third aspect, alone or in combination with one or more of the first and second aspects, the initial frequency error correction is based at least in part on the one or more reference signals received during the third time period based at least in part on satisfaction of one or more frequency error change metrics.

In a fourth aspect, alone or in combination with one or more of the first through third aspects, the one or more frequency error change metrics comprise one or more of satisfaction of a time duration threshold by the third time period, satisfaction of a frequency error change threshold by a change in frequency error of the second component carrier during the third time period, as measured via the one or more reference signals, or satisfaction of a temperature change threshold by a temperature change during the third time period.

In a fifth aspect, alone or in combination with one or more of the first through fourth aspects, one or more of the time duration threshold, the frequency error change threshold, or the temperature change threshold is based at least in part on one or more of a capability of the UE, a communication protocol, or an indication from a network node associated with the first component carrier or the second component carrier.

In a sixth aspect, alone or in combination with one or more of the first through fifth aspects, the initial frequency error correction being based at least in part on the one or more reference signals received during the third time period comprises the initial frequency error correction being based at least in part on a frequency error of the second component carrier at an end of the second time period, and a change in frequency error of the second component carrier during the third time period, as measured via the one or more reference signals.

In a seventh aspect, alone or in combination with one or more of the first through sixth aspects, the second component carrier comprises a secondary component carrier.

In an eighth aspect, alone or in combination with one or more of the first through seventh aspects, communication via the second component carrier during the fourth time period comprises transmitting a communication using the initial frequency error correction, or receiving a communication using the initial frequency error correction.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIG. 10. Additionally, or alternatively, the apparatus 1200 may be configured to perform one or more processes described herein, such as process 1100 of FIG. 11. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 and/or the transmission component 1204 may communicate via a first component carrier during a first time period. The reception component 1202 and/or the transmission component 1204 may communicate via a second component carrier during a second time period that at least partially overlaps with the first time period. The reception component 1202 may receive a first indication to deactivate the second component carrier during a third time period that is after the second time period and at least partially overlaps with the first time period. The reception component 1202 may receive one or more reference signals during the third time period. The reception component 1202 may receive a second indication to activate the second component carrier for communication during a fourth time period that is after the third time period. The reception component 1202 and/or the transmission component 1204 may communicate via the second component carrier during the fourth time period based at least in part on using an initial frequency error correction at a beginning of the fourth time period, the initial frequency error correction based at least in part on the one or more reference signals received during the third time period.

The reception component 1202 may receive a set of reference signals during the second time period and with a first periodicity wherein receiving the one or more reference signals during the third time period comprises receiving the one or more reference signals during the third time period with a second periodicity, wherein the first periodicity is shorter than the second periodicity.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: communicating via a first component carrier during a first time period; communicating via a second component carrier during a second time period that at least partially overlaps with the first time period; receiving a first indication to deactivate the second component carrier during a third time period that is after the second time period and at least partially overlaps with the first time period; receiving one or more reference signals during the third time period; receiving a second indication to activate the second component carrier for communication during a fourth time period that is after the third time period; and communicating via the second component carrier during the fourth time period based at least in part on using an initial frequency error correction at a beginning of the fourth time period, the initial frequency error correction based at least in part on the one or more reference signals received during the third time period.

Aspect 2: The method of Aspect 1, wherein the one or more reference signals comprises one or more synchronization signal blocks (SSBs).

Aspect 3: The method of any of Aspects 1-2, further comprising receiving a set of reference signals during the second time period and with a first periodicity, wherein receiving the one or more reference signals during the third time period comprises receiving the one or more reference signals during the third time period with a second periodicity, wherein the first periodicity is shorter than the second periodicity.

Aspect 4: The method of any of Aspects 1-3, wherein the initial frequency error correction is based at least in part on the one or more reference signals received during the third time period based at least in part on satisfaction of one or more frequency error change metrics.

Aspect 5: The method of Aspect 4, wherein the one or more frequency error change metrics comprise one or more of: satisfaction of a time duration threshold by the third time period; satisfaction of a frequency error change threshold by a change in frequency error of the second component carrier during the third time period, as measured via the one or more reference signals; or satisfaction of a temperature change threshold by a temperature change during the third time period.

Aspect 6: The method of Aspect 5, wherein one or more of the time duration threshold, the frequency error change threshold, or the temperature change threshold is based at least in part on one or more of: a capability of the UE, a communication protocol, or an indication from a network node associated with the first component carrier or the second component carrier.

Aspect 7: The method of any of Aspects 1-6, wherein the initial frequency error correction being based at least in part on the one or more reference signals received during the third time period comprises: the initial frequency error correction being based at least in part on: a frequency error of the second component carrier at an end of the second time period, and a change in frequency error of the second component carrier during the third time period, as measured via the one or more reference signals.

Aspect 8: The method of any of Aspects 1-7, wherein the second component carrier comprises a secondary component carrier.

Aspect 9: The method of any of Aspects 1-8, wherein communication via the second component carrier during the fourth time period comprises: transmitting a communication using the initial frequency error correction, or receiving a communication using the initial frequency error correction.

Aspect 10: An apparatus for wireless communication at a device, comprising a processor; memory coupled with the processor; and instructions stored in the memory and executable by the processor to cause the apparatus to perform the method of one or more of Aspects 1-9.

Aspect 11: A device for wireless communication, comprising a memory and one or more processors coupled to the memory, the one or more processors configured to perform the method of one or more of Aspects 1-9.

Aspect 12: An apparatus for wireless communication, comprising at least one means for performing the method of one or more of Aspects 1-9.

Aspect 13: A non-transitory computer-readable medium storing code for wireless communication, the code comprising instructions executable by a processor to perform the method of one or more of Aspects 1-9.

Aspect 14: A non-transitory computer-readable medium storing a set of instructions for wireless communication, the set of instructions comprising one or more instructions that, when executed by one or more processors of a device, cause the device to perform the method of one or more of Aspects 1-9.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
communicating via a first component carrier during a first time period;
communicating via a second component carrier during a second time period that at least partially overlaps with the first time period;
receiving a first indication to deactivate the second component carrier during a third time period that is after the second time period and at least partially overlaps with the first time period;
receiving a second indication to activate the second component carrier for communication during a fourth time period that is after the third time period; and
communicating via the second component carrier during the fourth time period based at least in part on using an initial frequency error correction at a beginning of the fourth time period, the initial frequency error correction based at least in part on a frequency error of the first component carrier during the third time period.

2. The method of claim 1, wherein the initial frequency error correction is based at least in part on the frequency error of the first component carrier during the third time period based at least in part on satisfaction of one or more frequency error change metrics.

3. The method of claim 2, wherein the one or more frequency error change metrics comprise one or more of:
satisfaction of a time duration threshold by the third time period;
satisfaction of a frequency error change threshold by a change in frequency error of the first component carrier during the third time period; or
satisfaction of a temperature change threshold by a temperature change during the third time period.

4. The method of claim 3, wherein one or more of the time duration threshold, the frequency error change threshold, or the temperature change threshold is based at least in part on one or more of:
a capability of the UE,
a communication protocol, or
an indication from a network node associated with the first component carrier or the second component carrier.

5. The method of claim 1, wherein the initial frequency error correction is based at least in part on a frequency error of the first component carrier during the third time period based at least in part on one or more of:
communications via the first component carrier and communications via the second component carrier using a same reception chain or transmission chain, or
the first component carrier and the second component carrier being within a same frequency range.

6. The method of claim 1, wherein the initial frequency error correction being based at least in part on a frequency error of the first component carrier during the third time period comprises:
the initial frequency error correction being substantially equal to a frequency error correction of the first component carrier that is based at least in part on the frequency error of the first component carrier at an end of the third time period.

7. The method of claim 1, wherein the initial frequency error correction being based at least in part on a frequency error of the first component carrier during the third time period comprises:
the initial frequency error correction being based at least in part on:
a frequency error of the second component carrier at an end of the second time period, and
a change in frequency error of the first component carrier during the third time period.

8. The method of claim 1, wherein the initial frequency error correction being based at least in part on a frequency error of the first component carrier during the third time period comprises:
the initial frequency error correction being based at least in part on:
the frequency error of the first component carrier at an end of the third time period, and
a difference between a frequency error of the second component carrier and a frequency error of the first component carrier during the second time period.

9. The method of claim 1, wherein the second component carrier comprises a secondary component carrier.

10. The method of claim 1, wherein communication via the second component carrier during the fourth time period comprises:
transmitting a communication using the initial frequency error correction, or
receiving a communication using the initial frequency error correction.

11. A user equipment (UE) for wireless communication, comprising:
a memory; and
one or more processors, coupled to the memory, configured to:
communicate via a first component carrier during a first time period;
communicate via a second component carrier during a second time period that at least partially overlaps with the first time period;
receive a first indication to deactivate the second component carrier during a third time period that is after the second time period and at least partially overlaps with the first time period;
receive a second indication to activate the second component carrier for communication during a fourth time period that is after the third time period; and
communicate via the second component carrier during the fourth time period based at least in part on using an initial frequency error correction at a beginning of the fourth time period, the initial frequency error correction based at least in part on a frequency error of the first component carrier during the third time period.

12. The UE of claim 11, wherein the initial frequency error correction is based at least in part on the frequency error of the first component carrier during the third time period based at least in part on satisfaction of one or more frequency error change metrics.

13. The UE of claim 12, wherein the one or more frequency error change metrics comprise one or more of:
satisfaction of a time duration threshold by the third time period;
satisfaction of a frequency error change threshold by a change in frequency error of the first component carrier during the third time period; or
satisfaction of a temperature change threshold by a temperature change during the third time period.

14. The UE of claim 13, wherein one or more of the time duration threshold, the frequency error change threshold, or the temperature change threshold is based at least in part on one or more of:
a capability of the UE,
a communication protocol, or
an indication from a network node associated with the first component carrier or the second component carrier.

15. The UE of claim 11, wherein the initial frequency error correction is based at least in part on a frequency error of the first component carrier during the third time period based at least in part on one or more of:
communications via the first component carrier and communications via the second component carrier using a same reception chain, or
the first component carrier and the second component carrier being within a same frequency range.

16. The UE of claim 11, wherein the initial frequency error correction being based at least in part on a frequency error of the first component carrier during the third time period comprises:
the initial frequency error correction being substantially equal to a frequency error correction of the first component carrier that is based at least in part on the frequency error of the first component carrier at an end of the third time period.

17. The UE of claim 11, wherein the initial frequency error correction being based at least in part on a frequency error of the first component carrier during the third time period comprises:
the initial frequency error correction being based at least in part on:
a frequency error of the second component carrier at an end of the second time period, and
a change in frequency error of the first component carrier during the third time period.

18. The UE of claim 11, wherein the initial frequency error correction being based at least in part on a frequency error of the first component carrier during the third time period comprises:
the initial frequency error correction being based at least in part on:
the frequency error of the first component carrier at an end of the third time period, and
a difference between a frequency error of the second component carrier and a frequency error of the first component carrier during the second time period.

19. The UE of claim 11, wherein the second component carrier comprises a secondary component carrier.

20. The UE of claim 11, wherein the one or more processors, to communicate via the second component carrier during the fourth time period, are configured to:
transmit a communication using the initial frequency error correction, or
receive a communication using the initial frequency error correction.

21. A non-transitory computer-readable medium storing a set of instructions for wireless communication, the set of instructions comprising:
one or more instructions that, when executed by one or more processors of a user equipment (UE), cause the UE to:
communicate via a first component carrier during a first time period;
communicate via a second component carrier during a second time period that at least partially overlaps with the first time period;
receive a first indication to deactivate the second component carrier during a third time period that is after the second time period and at least partially overlaps with the first time period;
receive a second indication to activate the second component carrier for communication during a fourth time period that is after the third time period; and
communicate via the second component carrier during the fourth time period based at least in part on using an initial frequency error correction at a beginning of the fourth time period, the initial frequency error correction based at least in part on a frequency error of the first component carrier during the third time period.

22. The non-transitory computer-readable medium of claim 21, wherein the initial frequency error correction is based at least in part on the frequency error of the first component carrier during the third time period based at least in part on satisfaction of one or more frequency error change metrics.

23. The non-transitory computer-readable medium of claim 22, wherein the one or more frequency error change metrics comprise:
satisfaction of a time duration threshold by the third time period;
satisfaction of a frequency error change threshold by a change in frequency error of the first component carrier during the third time period; or
satisfaction of a temperature change threshold by a temperature change during the third time period.

24. The non-transitory computer-readable medium of claim 21, wherein the initial frequency error correction is based at least in part on a frequency error of the first component carrier during the third time period based at least in part on one or more of:
communications via the first component carrier and communications via the second component carrier using a same reception chain, or
the first component carrier and the second component carrier being within a same frequency range.

25. The non-transitory computer-readable medium of claim 21, wherein the initial frequency error correction being based at least in part on a frequency error of the first component carrier during the third time period comprises:
the initial frequency error correction being substantially equal to a frequency error correction of the first component carrier that is based at least in part on the frequency error of the first component carrier at an end of the third time period.

26. An apparatus for wireless communication, comprising:
means for communicating via a first component carrier during a first time period;
means for communicating via a second component carrier during a second time period that at least partially overlaps with the first time period;
means for receiving a first indication to deactivate the second component carrier during a third time period that is after the second time period and at least partially overlaps with the first time period;
means for receiving a second indication to activate the second component carrier for communication during a fourth time period that is after the third time period; and
means for communicating via the second component carrier during the fourth time period based at least in part on using an initial frequency error correction at a beginning of the fourth time period, the initial frequency error correction based at least in part on a frequency error of the first component carrier during the third time period.

27. The apparatus of claim 26, wherein the initial frequency error correction is based at least in part on the frequency error of the first component carrier during the third time period based at least in part on satisfaction of one or more frequency error change metrics.

28. The apparatus of claim 27, wherein the one or more frequency error change metrics comprise:
satisfaction of a time duration threshold by the third time period;
satisfaction of a frequency error change threshold by a change in frequency error of the first component carrier during the third time period; or
satisfaction of a temperature change threshold by a temperature change during the third time period.

29. The apparatus of claim 26, wherein the initial frequency error correction is based at least in part on a frequency error of the first component carrier during the third time period based at least in part on one or more of:
communications via the first component carrier and communications via the second component carrier using a same reception chain, or
the first component carrier and the second component carrier being within a same frequency range.

30. The apparatus of claim 26, wherein the initial frequency error correction being based at least in part on a frequency error of the first component carrier during the third time period comprises:
the initial frequency error correction being substantially equal to a frequency error correction of the first component carrier that is based at least in part on the frequency error of the first component carrier at an end of the third time period.
